(19) United States
(12) Patent Application Publication
(10) Pub. No.: US 2014/0019225 A1
(43) Pub. Date: Jan. 16, 2014

(54) MULTI-CHANNEL, SELF-LEARNING, SOCIAL INFLUENCE-BASED INCENTIVE GENERATION

(71) Applicants: Scott M. Guminy, Newmarket (CA); Leho Nigul, Richmond Hill (CA)

(72) Inventors: Scott M. Guminy, Newmarket (CA); Leho Nigul, Richmond Hill (CA)

(73) Assignee: INTERNATIONAL BUSINESS MACHINES CORPORATION, Armonk, NY (US)

(21) Appl. No.: 13/545,627

(22) Filed: Jul. 10, 2012

(51) Int. Cl. G06Q 30/02

(52) U.S. Cl. 705/14.39

(57) ABSTRACT

A social networking action by a user within a social networking website that positively references a marketplace offering of an entity is detected by a processor. In response to detecting the social networking interaction by the user, a social networking influence of the user is determined based upon entity interactions by social network connections of the user with the entity by a number of entity access channels of the entity. A determination is made as to whether the determined social networking influence of the user satisfies a reward threshold defined within a social networking influence incentive rule. In response to determining that the determined social networking influence of the user satisfies the incentive threshold defined within the social networking influence incentive rule, an incentive defined within the social networking influence incentive rule is generated for the user.

### BACKGROUND

The present invention relates to advertising and marketing incentive generation. More particularly, the present invention relates to multi-channel, self-learning, social influence-based incentive generation.

Advertisers market products to increase sales of the products and to increase market share of brands of products. Advertisements may include information about products and promotions. Advertisements may also include time frames during which promotions are offered.

### BRIEF SUMMARY

A method includes detecting, via a processor, a social networking action by a user within a social networking website that positively references a marketplace offering of an entity; determining, in response to detecting the social networking interaction by the user, a social networking influence of the user based upon entity interactions by social network connections of the user with the entity via a plurality of entity access channels of the entity; determining whether the determined social networking influence of the user satisfies a reward threshold defined within a social networking influence incentive rule; and generating, in response to determining that the determined social networking influence of the user satisfies the incentive threshold defined within the social networking influence incentive rule, an incentive defined within the social networking influence incentive rule for the user.

A system includes a memory that stores social networking influence incentive rules; and a processor programmed to: detect a social networking action by a user within a social networking website that positively references a marketplace offering of an entity; determine, in response to detecting the social networking interaction by the user, a social networking influence of the user based upon entity interactions by social network connections of the user with the entity via a plurality of entity access channels of the entity; determine whether the determined social networking influence of the user satisfies a reward threshold defined within a social networking influence incentive rule; and generate, in response to determining that the determined social networking influence of the user satisfies the incentive threshold defined within the social networking influence incentive rule, an incentive defined within the social networking influence incentive rule for the user.

A computer program product includes a computer readable storage medium including computer readable program code, where the computer readable program code when executed on a computer causes the computer to detect a social networking action by a user within a social networking website that positively references a marketplace offering of an entity; determine, in response to detecting the social networking interaction by the user, a social networking influence of the user based upon entity interactions by social network connections of the user with the entity via a plurality of entity access channels of the entity; determine whether the determined social networking influence of the user satisfies a reward threshold defined within a social networking influence incentive rule; and generate, in response to determining that the determined social networking influence of the user satisfies the incentive threshold defined within the social networking influence incentive rule, an incentive defined within the social networking influence incentive rule for the user.

### BRIEF DESCRIPTION OF THE SEVERAL VIEWS OF THE DRAWINGS

FIG. 1 is a block diagram of an example of an implementation of a system for automated multi-channel, self-learning, social influence-based incentive generation according to an embodiment of the present subject matter;

FIG. 2 is a block diagram of an example of an implementation of a core processing module capable of performing automated multi-channel, self-learning, social influence-based incentive generation according to an embodiment of the present subject matter;

FIG. 3 is a flow chart of an example of an implementation of a process for automated multi-channel, self-learning, social influence-based incentive generation according to an embodiment of the present subject matter;

FIG. 4A is a flow chart of an example of an implementation of initial processing within a process for automated multi-channel, self-learning, social influence-based incentive generation according to an embodiment of the present subject matter;

FIG. 4B is a flow chart of an example of an implementation of additional processing within a process for automated multi-channel, self-learning, social influence-based incentive generation according to an embodiment of the present subject matter; and

FIG. 4C is a flow chart of an example of an implementation of additional processing within a process for automated multi-channel, self-learning, social influence-based incentive generation according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides multi-channel, self-learning, social influence-based incentive generation. Social networking actions by a user within a social networking website that positively or negatively reference a marketplace offering of an entity (e.g., a product, service, promotional campaign, etc.) are detected. A social networking influence of the user is determined based upon entity interactions by social network connections (e.g., friends, followers, etc.) of the user with the entity via a group of different forms of entity access channels of the entity, such as websites, call centers, kiosks, point of sale (POS) terminals, etc.). A determination is made as to whether the determined social networking influence of the user satisfies a reward threshold defined within a social networking influence incentive rule. An incentive defined within the social networking influence incentive rule for the user is generated in response to determining that the social networking influence of the user satisfies the incentive threshold defined within the social networking influence incentive rule. Changes in the social networking influence of the user over time may be determined and incentives may be adjusted to further incentivize increased social networking influence. Further, the effectiveness of generated incentives may be evaluated over time and adjusted, again to further incentivize increased social networking influence.

As such, the present technology provides customized and relevant rewards for system users that share information related to products, services, and other types of offerings (e.g., “checking in” on certain social network sites, social and/or political campaigns, etc.) on social networks. As such, the present technology assists businesses with directing more traffic and profits to their businesses. The present technology allows businesses to learn more about their customers and the effectiveness of their marketing initiatives, and allows businesses to learn more about the effectiveness of social networks within the context of the incentive approach described herein.

The multi-channel, self-learning, social influence-based incentive generation described herein is not limited to “for profit” entity use. The present technology may also be utilized by charitable or other organizations, political parties, or other entities to couple/correlate donation collections or supporter increases to the social networking influence of persons, and incentives may be generated for products or services of other entities in response to influence-based donations or supporter increases. As such, many variations on a business domain implementation of the present technology are possible and all are considered within the scope of the present subject matter.

For purposes of the present description, the phrase “social network connection” refers to a person related within and by a social network system to a social network system/website user, such as a “friend” and “follower” of the user, and other social networking types of relationships as appropriate for the particular form of social network. The present technology may utilize application programming interface (API) technology and API calls to social networking applications/servers to identify different social groups to which a user belongs, and to identify/determine which other people (social network connections) are in those particular social groups.

Additionally, the present technology utilizes the concept of integration of multiple “entity access channels” to correlate user influence of purchases/support by others within social networks (among their social network associates—friends/followers, etc.) across different business interaction venues. The entity access channels each represent customer/supporter interfaces to a particular business entity, political entity, non-profit entity, or other entity. The entity access channels are referred to herein alternatively as “customer touch points,” “touch points,” and “business channels.” For example, entity access channels may include any venues by which customers/supporters may interact with or communicate with entities, such as websites, call centers, kiosks, point of sale (POS) devices, and other business interaction venues. Further, a “marketplace offering” of an entity may include a product offered for sale by a business, a campaign that is in process by a political party, an article or other matter written by an author and/or published for subscription or any other purpose, or any marketed item or cause for which a sale or support is desired by the entity. Similarly, the phrase “social networking action” as used herein refers to a user interaction within a social networking website that references a marketplace offering of an entity, and may include either a positive or a negative reference to that offering unless otherwise specified. For example, a social networking action may include “liking” a marketplace offering, commenting on a marketplace offering such as within a product page, “checking in” or “pinning an article” on certain social network sites, or other actions as appropriate for a given implementation.

As such, multiple entity access channels are available and are used by the present technology for analysis and social influence-based determinations and incentive generation. Each of these interactions, and therefore each of these customer touch points or business channels provide information that may be used to increase knowledge that a business has about its customers, and the influence that users of the present technology have upon their friends within social networks. The present technology integrates and combines knowledge gained from these different customer touch points or business channels to make incentive generation more precise and relevant to the particular users. The terms “customer touch points” and “business channels” are used interchangeably herein.

Data associated with a user/customer may be obtained from information associated with customer touch points by a behavior collector. The data may include data records of behavior of a customer in the various touch points. The data may also include indications of actions that are performed by social network connections (e.g., friends, followers, etc.) of the social networking website user in response to the user's social networking activity on the social networking website related to marketplace offerings of entities. The behavior collector may be implemented as a pluggable framework capable of tracking various types of activities performed in response to social networking actions. The activities may include activities on a website including browsing products, adding items to a shopping cart, reviewing products, and may include call center interactions or kiosk/POS interactions, or other activities associated with entity access channels as appropriate for a given implementation.

The gathered data may be analyzed and mapped to specific social networking activity, and may be mapped to product purchasing transactions or other activities that indicate a positive result of social networking influence. The mapping provides data regarding “outcomes” of social networking interaction and social networking actions by users. For example, if someone tweets positively about a product, the present technology may be utilized to determine how many people bought the product based upon that particular tweet. As such, social networking user influence determination may be informed by use of the present technology.

With information on influence determined, incentive generation may be performed based upon the results of determined influence within the social networking environments. As such, a set of suggestions may be generated, using the analyzed data of social networking influence, that include one or more suggestions for an incentive using predefined reward/incentive rules that define conditions for rewarding specific users. As such, the suggestions may be considered reward definitions or reward rules. For example, reward rules may be created that reward positive behavior. Further, the reward rules may be highly customized based upon an incentive profile and effects of user interactions/influence within one or more social circuits/networks. The user's interactions/influence may be monitored over time. The incentive profile may be updated based upon the monitored interactions/influence over time, and the suggestions for incentives and resulting incentives generated may be changed over time to further incentivize the user. Accordingly, a set of customized and relevant rewards may be associated with each customer based upon their analyzed influence within one or more social circuits/networks.

By integrating social networking influence-based determinations with incentive generation, the present technology provides shoppers with incentives to participate or participate at a higher level in social networking websites. As such, brands may be spread more organically by user influence within social networks, for example, where consumers are provided with opportunities to buy products from particular websites. Website revenues may also increase based upon the present technology of mapping influence from social networks to incentive generation, as described herein.

Based upon the mapped influence determined from social networking interactions and product acquisitions, categories of consumers may be selected for different reward levels. For example, the most influential people may be selected for the highest rewards. As such, the most influential people may be targeted for additional influence-based marketing opportunities. Less influential people may still be targeted and still get a reward to attempt to incentivize those persons to become more influential within their social networks to receive higher rewards. As such, a positive feedback approach may be implemented to further improve both influence of persons within their social networks, with a coincident positive increase in both sales to friends/followers of the persons, and a positive increase in incentives to those persons to be further influential. Accordingly, increased motivation to increase influence by social networking users may be achieved on social networking websites themselves based upon the positive reinforcement that may result from implementation of the present technology in association with any such website.

A rule engine may be configured to process the social networking interactions and product interaction markers, to make decisions regarding incentives, and to generate those incentives. Product interaction markers may include a number of persons that browse products suggested via a social networking interaction, a number of persons that search for and add items to a shopping cart, and a number of persons that review products in response to influential statements from users. Many variations on product interaction markers are possible and all are considered within the scope of the present subject matter.

Predefined reward rules that define conditions for rewarding specific customers/supporters may be defined and stored in a rule repository of a pluggable reward rule engine. Further, the rules may be updated programmatically in response to programmatic analysis of success levels associated with particular rule formats/levels to drive increased efficiency and correlation of incentive rules with positive purchasing or support decisions by persons influenced by the incentives generated by the rules. As such, the incentive rules may be considered suggestions that include a reward definition and a recommendation for a customer touch point through which the reward should be delivered, and these definitions may be refined over time based upon their success.

Regarding rule application to product interaction markers, incentives may be generated in a granular manner based upon a variety of factors. For example, if it is determined that three (3) people purchase a product (added to shopping cart) and that two (2) additional persons browsed the product in response to a recommendation from a user on a social networking website, the user may be given a particular level of discount on a product purchase. Alternatively, if it is determined that three hundred (300) people purchase a product and that two thousand (2000) additional people browsed the product in response to a recommendation from a user on a social networking website, the user may be given a courtesy telephone call thanking the user for the good recommendation along with a higher discount on a product purchase.

The present technology performs predictive analysis with regard to a level of relevance of a specific incentive in the set of suggestions to a respective customer using a self-learning analytics module. The self-learning analytics module utilizes the predictive analysis in combination with actual results to refine incentives and incentive offerings over time.

It should be noted that a person that receives an incentive or a reward does not need to be a customer of a particular business or support a particular cause to be rewarded using the present technology. For example, a person that is not a customer may have influence and recommend a product that is seen while shopping either within a store or online, and if this user generates positive information (e.g., a celebrity says a good thing about a product or service) that results in sales or product reviews, that person may be rewarded or receive a courtesy telephone call thanking them for their positive statements. Many variations on inventive rules and granularity are possible and all are considered within the scope of the present subject matter.

It should be noted that conception of the present subject matter resulted from recognition of certain limitations associated with advertising and advertising incentives. For example, it was observed that, while advertisers desire to increase sales, brand recognition, and market share, previous advertisement approaches are limited with respect to the information provided to advertisers and problematic because different consumers often respond differently to the same incentives. Further, it was observed that advertisers are limited with respect to learning how different consumers respond to incentives that are provided. Additionally, it was observed that while people often “tweet” about experiences with retailers and other organizations (e.g., in-store, online shopping experiences, call center experiences, etc.) and share this information on social media websites, there is no way within the previous/existing systems to correlate influence with respect to purchasing decisions for different types of users (e.g., celebrities with lots of followers versus users with small circles of friends) among their friends/followers. The present subject matter improves advertising and marketing by providing for influence-based incentive generation that is performed in response to programmatic determinations of user influence within social media circles and social networks. Additionally, multiple venues/channels of product acquisition are integrated and the processing described herein self-learns user influence patterns by analyzing responses (e.g., purchases, donations, etc.) across the varied multiple venues/channels by friends and followers of users that influence those responses. Users are further incentivized to influence friends in a highly-granular manner based upon their determined influence. The present technology enables businesses to offer the most desired and comprehensive incentives to different segments of their customers based upon higher determined influence. As such, improved advertising and marketing may be obtained through the multi-channel, self-learning, social influence-based incentive generation described herein.

The multi-channel, self-learning, social influence-based incentive generation described herein may be performed in real time to allow prompt generation and distribution of differing incentives based upon differing levels of influence social network users have within their social networks. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

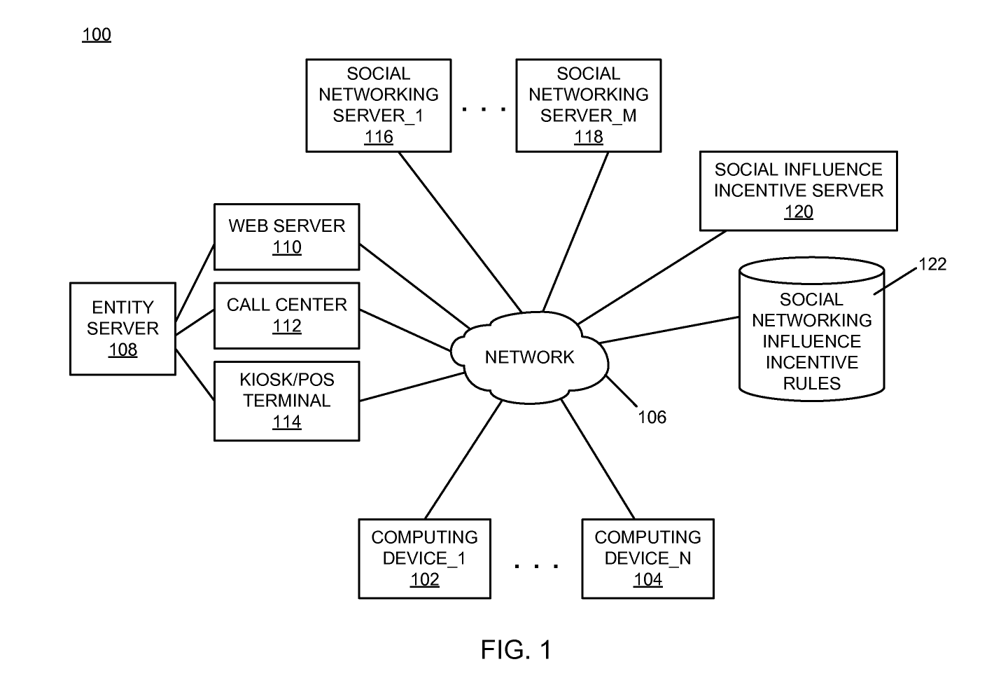

FIG. 1 is a block diagram of an example of an implementation of a system 100 for automated multi-channel, self-learning, social influence-based incentive generation. A computing device_{—}1 102 through a computing device_N 104 communicate via a network 106 with other of the respective computing devices and with several other devices. The other devices include an entity server 108. The entity server 108 may be operated by a business, political, or other entity. The entity server 108 is accessible to customers, consumers, supporters, etc., via multiple entity access channels (e.g., customer touch points), such as a web server 110, a call center 112, and a kiosk/point of sale (POS) terminal 114. The computing device_{—}1 102 through the computing device_N 104 also communicate with a social networking server_{—}1 116 through a social networking server_M 118 that allow users of the computing device_{—}1 102 through the computing device_N 104 to interact with each other for purposes of social networking.

A social influence incentive server 120 monitors and tracks comments and suggestions of users of the computing device_{—}1 102 through the computing device_N 104 within the social networks established via the social networking server_{—}1 116 through the social networking server_M 118. The influence of these users is analyzed via interactions (e.g., sales, product inquiries, etc.) by friends/followers of the users across the available multiple entity access channels (e.g., customer touch points) that are represented generally within the present example by the web server 110, the call center 112, and the kiosk/point of sale (POS) terminal 114.

The social influence incentive server 120 analyzes the activities of the friends/followers of the users across the available multiple entity access channels using influence-based incentive rules stored within a social networking influence incentive rules database 122. The social networking influence incentive rules database 122 may be pre-populated with influence-based incentive rules generated by an entity that operates the entity server 108. The social influence incentive server 120 may modify and enhance these pre-generated rules over time based upon the results of the analysis of influence of users of the respective computing devices among their friends/followers.

Additionally or alternatively, the social influence incentive server 120 may analyze user influence within the respective social networks over time and generate influence-based incentive rules based upon the results of the analysis of user influence. As such, the entity that operates the entity server 108 may be relieved of the task of determining the incentives and may utilize the services of the social influence incentive server 120 to optimize the incentive offerings based upon actual results within a particular deployed environment. Where the social influence incentive server 120 generates influence-based incentive rules, the social influence incentive server 120 may populate the social networking influence incentive rules database 122 with the generated rules to store the generated influence-based incentive rules for use and refinement by the social influence incentive server 120 over time, again based upon actual results of analysis of social influence by users of the computing device_{—}1 102 through the computing device_N 104 within the respective social networks implemented by the social networking server_{—}1 116 through the social networking server_M 118.

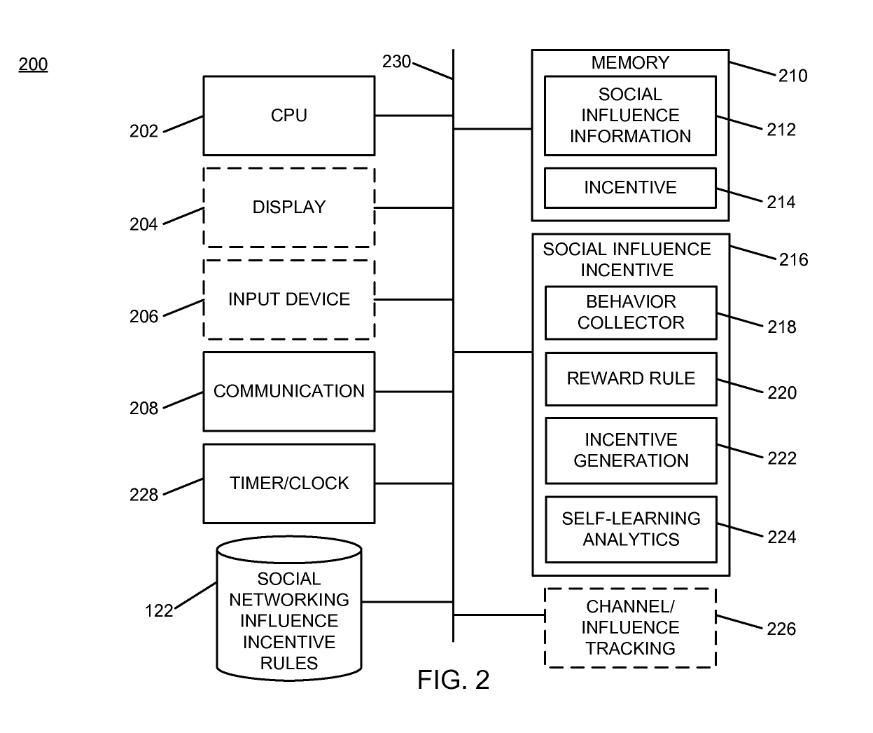

As will be described in more detail below in association with FIG. 2 through FIG. 4C, the social influence incentive server 120 provides automated multi-channel, self-learning, social influence-based incentive generation. The computing device_{—}1 102 through the computing device_N 104, the social networking server_{—}1 116 through the social networking server_M 118, and the entity server 108, the web server 110, the call center 112, and the kiosk/point of sale (POS) terminal 114 may each be configured to collect and contribute information useable by the social influence incentive server 120 to provide the automated multi-channel, self-learning, social influence-based incentive generation. As such, a variety of possibilities exist for implementation of the present subject matter, and all such possibilities are considered within the scope of the present subject matter.

It should be noted that the any of the respective computing devices described in association with FIG. 1 may be a portable computing device, either by a user's ability to move the respective computing device to different locations, or by the respective computing device's association with a portable platform, such as a plane, train, automobile, or other moving vehicle. It should also be noted that the respective computing devices may be any computing devices capable of processing information as described above and in more detail below. For example, the respective computing devices may include devices such as a personal computer (e.g., desktop, laptop, etc.) or a handheld device (e.g., cellular telephone, personal digital assistant (PDA), email device, music recording or playback device, etc.), or any other device capable of processing information as described above and in more detail below.

The network 106 may include any form of interconnection suitable for the intended purpose, including a private or public network such as an intranet or the Internet, respectively, direct inter-module interconnection, dial-up, wireless, or any other interconnection mechanism capable of interconnecting the respective devices.

FIG. 2 is a block diagram of an example of an implementation of a core processing module 200 capable of performing automated multi-channel, self-learning, social influence-based incentive generation. The core processing module 200 may be associated with the social influence incentive server 120 for monitoring, analysis, and evaluation of user influence with respect to purchases/donations and purchase decisions or information inquiries within social networks. The core processing module 200 may be associated with the computing device_{—}1 102 through the computing device_N 104, the social networking server_{—}1 116 through the social networking server_M 118, the entity server 108, the web server 110, the call center 112, and the kiosk/point of sale (POS) terminal 114, as appropriate for a given implementation of the present technology. As such, the core processing module is described generally herein, though it is understood that many variations on implementation of the components within the core processing module 200 are possible and all such variations are within the scope of the present subject matter.

Further, the core processing module 200 may provide different and complementary processing of social influence-based incentives in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 provides computer instruction execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, or any other type of input device by which the user may interact with and respond to information on the display 204.

It should be noted that the display 204 and the input device 206 are illustrated with a dashed-line representation within FIG. 2 to indicate that they may be optional components for the core processing module 200 for certain implementations/devices. Accordingly, the core processing module 200 may operate as a completely automated embedded device without direct user configurability or feedback. However, the core processing module 200 may also provide user feedback and configurability via the display 204 and the input device 206, respectively, as appropriate for a given implementation.

A communication module 208 provides interconnection capabilities that allow the core processing module 200 to communicate with other modules within the system 100. The communication module 208 may include any electrical, protocol, and protocol conversion capabilities useable to provide the interconnection capabilities.

A memory 210 includes a social influence information storage area 212 that stores monitored/tracked and/or analyzed information associated with the social influence of persons/users of the computing device_{—}1 102 through the computing device_N 104 within the social network(s) established by the social networking server_{—}1 116 through the social networking server_M 118. It is understood that where the core processing module 200 is associated with devices other than the social influence incentive server 120, the social influence information may represent raw data accessible and usable by the social influence incentive server 120 to analyze and evaluate social influence, and to generate and distribute rewards to users determined to have influence within their respective social network(s). It is also understood that where the core processing module 200 is associated with the social influence incentive server 120, the social influence information may represent both raw and processed social influence information.

The memory 210 also includes an incentive storage area 214. The incentive storage area 214 may be used to store incentives for distribution to users determined to have influence according to the social networking influence incentive rules or received as a result of the determined influence, as appropriate for the particular device with which the core processing module 200 is associated.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A social influence incentive module 216 is also illustrated. The social influence incentive module 216 provides analytical processing and analysis of social influence and generation of incentives for the core processing module 200, as described above and in more detail below. The social influence incentive module 216 implements the automated multi-channel, self-learning, social influence-based incentive generation of the core processing module 200.

Several modules/components are illustrated in association with the social influence incentive module 216. A behavior collector module 218 tracks at least two types of data. The behavior collector module 218 records actions performed by the friends/followers of the customer/user in response to customer/user activity on the respective social network. The behavior collector module 218 tracks various types of activities performed in response to social networking actions. The activities may include activities on a website, such as browsing products, adding items to a shopping cart, reviewing products, and may include call center interactions or kiosk/POS interactions, or other activities associated with entity access channels as appropriate for a given implementation. The behavior collector module 218 also records the behavior of the customer/user himself or herself in various touch points. This information may include how many times the customer/user calls a call center, what physical store the customer/user visits most often, information regarding whether the customer/user ever shops through mobile devices, etc. As such, the behavior collector module 218 collects a variety of information for analysis and evaluation by the social influence incentive module 216. The behavior collector module 218 may be a pluggable framework when implemented as an application-level component executed by the CPU 202.

Additionally, a reward rule module 220 is associated with the social influence incentive module 216 and allows definition of social networking influence incentive rules to specify conditions for rewarding certain customers/users. As described above, the defined social networking influence incentive rules may be stored within the social networking influence incentive rules database 122. A retailer, political campaign, or other entity may define a set of rules that determine when and what type of rewards the shopper/supporter would get from their social networking friends' activities based on the information available from different entity access channels. For example, a rule may be defined that specifies that if a social networking website user with a configurable number of followers/friends (e.g., ten thousand) on a particular social networking website “liked” the entity's product, service, or store, then the user is to be given a personalized call to thank him/her for good feedback on the particular product, service, or store. As another example, a rule may be defined that specifies that if a person dislikes a product from a competitor of the entity, an e-mail may be sent to this person with a coupon for a similar, but better, product or service provided by the entity. Another example rule may be defined that specifies that if a customer/supporter shares a link to a certain product on an entity's website with his/her friends and a configurable number (e.g., ten) of friends click on this link and make a purchase, the customer/supporter may be sent a gift certificate valid in a physical store where customer/supporter often shops (e.g., based on collected channel information). Many other rules are possible and all are considered within the scope of the present subject matter. The reward rule module 220 may also be a pluggable framework when implemented as an application-level component executed by the CPU 202.

Further, an incentive generation module 222 is associated with the social influence incentive module 216 and analyses user data from social networks, as well as from other customer touch points (entity access channels) and produces a suggestion for one or more incentives based on the defined reward rules, customer behavior, and self-learning analytics information available for the given user and customers/supporters. The outcome of the incentive generation module 222 is a reward definition and a suggestion for a touch point (channel) through which that reward should be delivered. For example, the outcome may specify to give the user a ten dollar ($10.00) credit the next time the user logs into the company website. Alternatively, the outcome may specify to give a user ten dollars ($10.00) off of their next purchase when three (3) of their friends have visited the website. As an additional example, the outcome may specify to give a user free shipping if any of their friends purchase a product. Many additional variations on outcomes that specify both a reward definition and a channel through which to deliver the reward are possible and all are considered within the scope of the present subject matter.

A self-learning analytics module 224 is associated with the social influence incentive module 216 and is responsible for performing predictive analysis with regard to the level of relevance of specific incentives to users based upon their determined influence among their social network(s). For example, if for the two previous times a user is sent a coupon that coupon is never redeemed, this reward will be automatically given lower relevancy standing for this particular user (or for multiple users generally if similar results are determined across categories of users). Conversely, if it is detected that after receiving a “thank you” e-mail the user makes more purchases in the physical stores, the relevancy score of “appreciation type” of rewards may be increased for the given user. Based upon these examples, the self-learning analytics module 224 may combine the analytics of users' social circle actions with other e-commerce and conventional (e.g., brick and mortar stores, kiosks, POS terminals, etc.) channel information in determining a proper reward for the given user's social networking actions. As such, the self-learning analytics module 224 may determine the best reward to offer to each user based on their multi-channel behavior patterns, to get the best exposure of the particular entity. Once again, many variations on predictive analysis and reward adjustment are possible and all are considered within the scope of the present subject matter.

It should also be noted that the social influence incentive module 216 may form a portion of other circuitry described without departure from the scope of the present subject matter. Further, the social influence incentive module 216 may alternatively be implemented as an application stored within the memory 210. In such an implementation, the social influence incentive module 216 may include instructions executed by the CPU 202 for performing the functionality described herein. The CPU 202 may execute these instructions to provide the processing capabilities described above and in more detail below for the core processing module 200. The social influence incentive module 216 and/or any of its components may form a portion of an interrupt service routine (ISR), a portion of an operating system, a portion of a browser application, or a portion of a separate application without departure from the scope of the present subject matter.

A channel/influence tracking module 226 is usable by any device within a system, such as the system 100 of FIG. 1, that is configured to monitor and/or track any of the available multiple entity access channels (e.g., customer touch points). The channel/influence tracking module 226 is also usable by devices, such as the computing device_{—}1 102 through the computing device_N 104 and the social networking server_{—}1 116 through the social networking server_M 118 to collect social influence information useable by the social influence incentive server 120 to analyze the activities of the friends/followers of the users across the available multiple entity access channels. As described above, the social influence incentive server 120 may utilize the information gathered across the respective system and social networks using the influence-based incentive rules stored within the social networking influence incentive rules database 122. It should be noted that the channel/influence tracking module 226 is illustrated with a dashed-line representation within FIG. 2 to indicate that this module may be an optional component for the core processing module 200 for certain implementations/devices, such as the social influence incentive server 120. However, it should be noted that the social influence incentive server 120 may also be configured to directly collect information related to the social influence of users. The behavior collector module 218 of the social influence incentive module 216 may gather information collected by the channel/influence tracking module 226 for analysis and evaluation by the social influence incentive module 216.

A timer/clock module 228 is illustrated and used to determine timing and date information, such as a time periods over which to collect data regarding actions of social network connections (e.g., friends, followers, etc.) of a user in response to a positive or negative social networking action that references a marketplace offering of an entity, as described above and in more detail below. As such, the social influence incentive module 216 may utilize information derived from the timer/clock module 228 for information processing activities, such as the automated multi-channel, self-learning, social influence-based incentive generation described herein.

The social networking influence incentive rules database 122 is also shown associated with the core processing module 200 within FIG. 2 to show that the social networking influence incentive rules database 122 may be coupled to the core processing module 200 without requiring external connectivity, such as via the network 106.

The CPU 202, the display 204, the input device 206, the communication module 208, the memory 210, the social influence incentive module 216, the channel/influence tracking module 226, the timer/clock module 228, and the social networking influence incentive rules database 122 are interconnected via an interconnection 230. The interconnection 230 may include a system bus, a network, or any other interconnection capable of providing the respective components with suitable interconnection for the respective purpose.

Though the different modules illustrated within FIG. 2 are illustrated as component-level modules for ease of illustration and description purposes, it should be noted that these modules may include any hardware, programmed processor(s), and memory used to carry out the functions of the respective modules as described above and in more detail below. For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. For a distributed arrangement, the display 204 and the input device 206 may be located at a point of sale (POS) device, kiosk, or other location, while the CPU 202 and memory 210 may be located at a local or remote server. Many other possible arrangements for components of the core processing module 200 are possible and all are considered within the scope of the present subject matter. It should also be understood that, though the social networking influence incentive rules database 122 is shown as a separate module/component, the information stored within the social networking influence incentive rules database 122 may also be stored within the memory 210 without departure from the scope of the present subject matter. Accordingly, the core processing module 200 may take many forms and may be associated with many platforms.

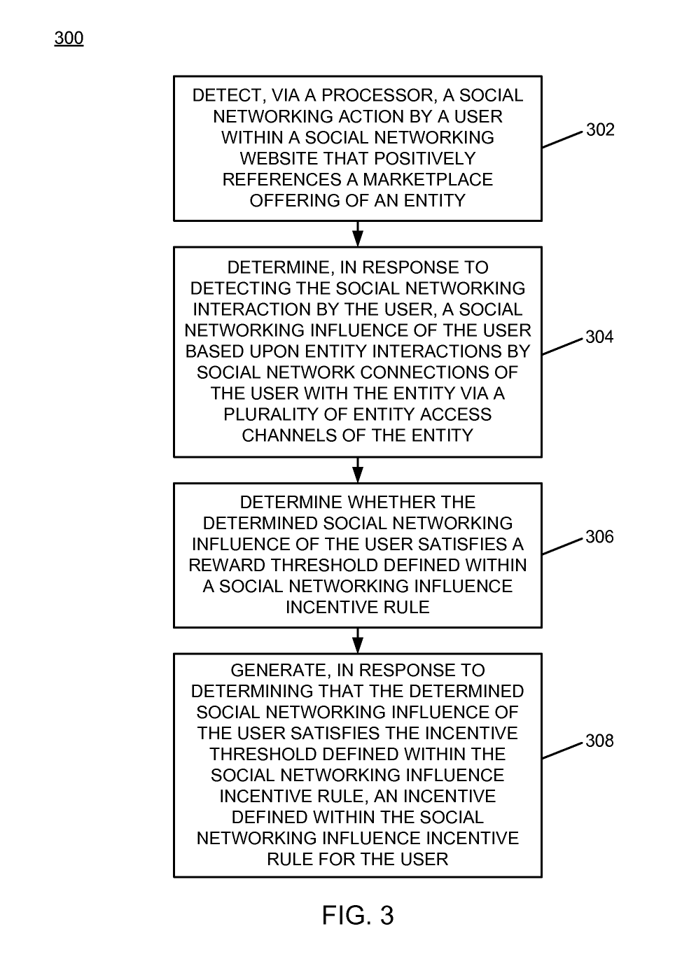

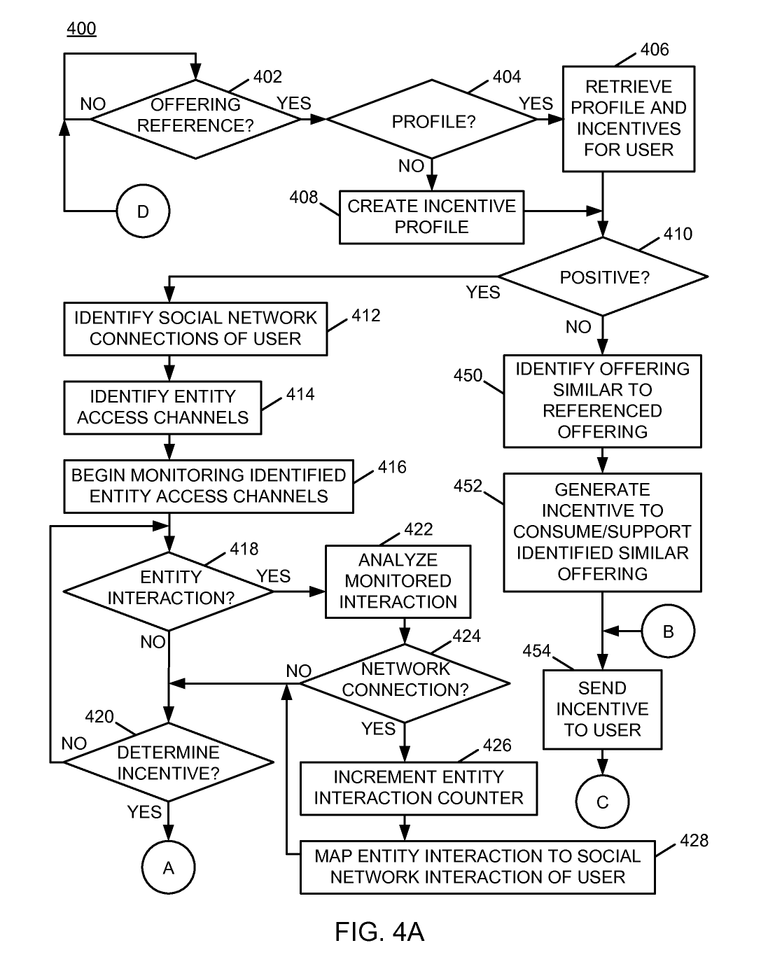

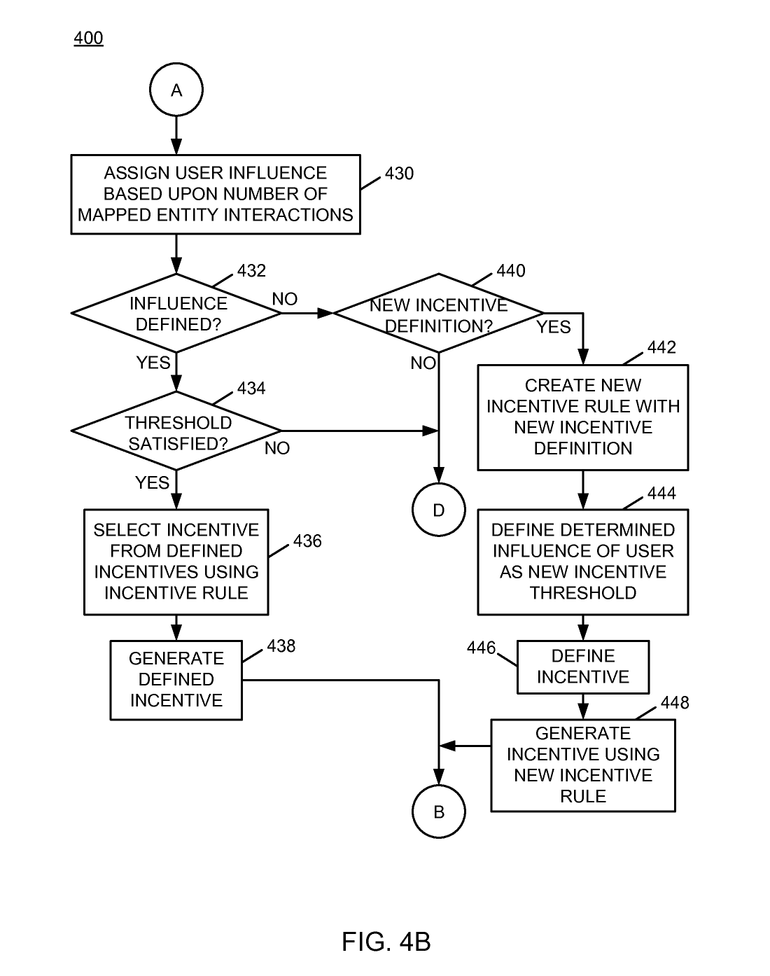

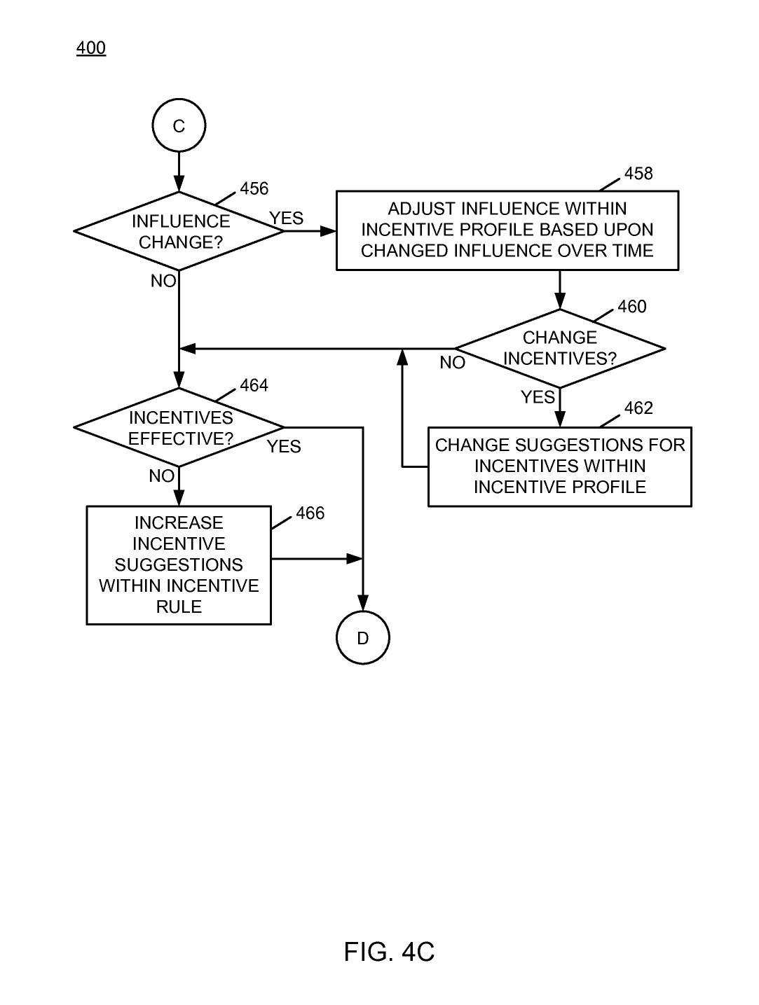

FIG. 3 through FIG. 4C described below represent example processes that may be executed by devices, such as the core processing module 200, to perform the automated multi-channel, self-learning, social influence-based incentive generation associated with the present subject matter. Many other variations on the example processes are possible and all are considered within the scope of the present subject matter. The example processes may be performed by modules, such as the social influence incentive module 216 and/or executed by the CPU 202, associated with such devices. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 3 is a flow chart of an example of an implementation of a process 300 for automated multi-channel, self-learning, social influence-based incentive generation. At block 302, the process 300 detects, via a processor, a social networking action by a user within a social networking website that positively references a marketplace offering of an entity. At block 304, the process 300 determines, in response to detecting the social networking interaction by the user, a social networking influence of the user based upon entity interactions by social network connections of the user with the entity via a plurality of entity access channels of the entity. At block 306, the process 300 determines whether the determined social networking influence of the user satisfies a reward threshold defined within a social networking influence incentive rule. At block 308, the process 300 generates, in response to determining that the determined social networking influence of the user satisfies the incentive threshold defined within the social networking influence incentive rule, an incentive defined within the social networking influence incentive rule for the user.

FIGS. 4A-4C illustrate a flow chart of an example of an implementation of a process 400 for automated multi-channel, self-learning, social influence-based incentive generation. FIG. 4A illustrates initial processing within the process 400. At decision point 402, the process 400 makes a determination as to whether a marketplace offering reference has been detected. For example, the process 400 may make a determination that a social networking action, such as a user “liking” the marketplace offering, commenting with respect to a marketplace offering, promoting a hypertext link of the marketplace offering to friends/followers, or some other form of social networking action associated with a social networking website, has been detected. In response to determining that a marketplace offering reference has been detected, the process 400 makes a determination as to whether a user incentive profile exists for the user with which the social networking action that references marketplace offering was detected at decision point 404. In response to determining that an incentive profile exists for the user at decision point 404, the process 400 retrieves the incentive profile and incentives for the user at block 406. Alternatively, in response to determining that an incentive profile does not exist for the user at decision point 404, the process 400 creates an incentive profile for the user at block 408.

In response to retrieving the incentive profile and incentives for the user at block 406 or creating the incentive profile for the user at block 408, the process 400 makes a determination at decision point 410 as to whether the detected marketplace offering reference was a positive reference or negative reference. Processing in response to determination that the detected marketplace offering reference was a negative reference will be deferred and described in more detail below.

In response to determining that the detected marketplace offering reference was a positive reference with respect to the marketplace offering at decision point 410, the process 400 identifies social network connections of the user at block 412. Social connections of the user include friends, followers, or other social networking system relationships with persons, whether formalized or un-formalized, by way of one or more social networking websites/systems. As such, the process 400 identifies all of those friends/followers and others connected to the user via one or more social networking websites/systems.

At block 414, the process 400 identifies the available entity access channels for the entity associated with the marketplace offering (e.g., the business, the political campaign, the non-profit organization, etc.). As described above, entity access channels may include web servers, call centers, kiosks, POS devices, etc. At block 416, the process 400 begins monitoring the identified entity access channels to detect subsequent entity interactions by the social network connections (friends/followers, etc.) of the user with the entity by way of the identified entity access channels of the entity. The process 400 may configure a monitoring time period, such as by use of the timer/clock module 228, for use in determining when to evaluate/analyze entity interactions by the social network connections of the user to determine an appropriate incentive for the user.

At decision point 418, the process 400 makes determination as to whether an entity interaction (e.g., any interactions subsequent to the marketing offering reference) by way of one of the identified any access channels has been detected. It should be noted that an entity interaction may be performed by a social network connection of the user or by other persons that are unconnected and unrelated to the user. Processing is performed by the process 400, as described in detail below, to differentiate between the two groups of persons that interact with the entity.

For purposes of the present example, it is assumed that at least one entity interaction is detected at some point during processing by the process 400, as described in more detail below. A description of the processing performed in response to an entity interaction is deferred and described in detail further below in favor of a present description of higher-level loop processing associated with the process 400. As such, in response to determining that an entity interaction by way of one of the identified any access channels has not been detected, the process 400 makes a determination as to whether to determine the appropriate incentive for the user based upon entity interactions by the social network connections of the user at decision point 420. For example, as described above, where the process 400 is configured to monitor a time period, the process 400 may determine whether that time period has expired at decision point 420. Alternatively, the process 400 may use an entity interaction counter as referenced further below to determine whether an entity interaction threshold has been met. As such, even where a configured time period is established for making determinations with respect to incentives, for circumstances where a user's influence causes a large number of social network connections to very rapidly begin interactions with the entity associated with the marketplace offering, the entity interaction threshold may allow an incentive to be generated earlier than the configured time period. In response to determining not to determine the appropriate incentive for the user based upon entity interactions by the social network connections of the user at decision point 420 (i.e., to continue monitoring the identified entity access channels and to defer determining the incentive for the user), the process 400 returns to decision point 418 as part of the higher-level loop processing and iterates as described above.

Returning to decision point 418, in response to determining that an entity interaction by way of one or more of the identified entity access channels has been detected, the process 400 analyzes the monitored subsequent entity interaction(s) with the entity via the entity access channel of the entity associated with the detected entity interaction at block 422. At decision point 424, the process 400 makes a determination as to whether the detected and analyzed entity interaction was performed by one of the social network connections of the user. In response to determining that the detected and analyzed entity interaction was not performed by one of the social network connections of the user, the process 400 returns to decision point 420 and iterates as described above.

In response to determining that the detected and analyzed entity interaction was performed by one of the social network connections of the user at decision point 424, the process 400 increments an entity interaction counter at block 426. At block 428, the process 400 maps the entity interaction to the initially detected social networking interaction associated with the positive reference to the marketplace offering. As such, the process 400 maps the number of monitored subsequent entity interactions determined to have been performed by the identified social network connections of the user to the detected the social networking interaction by the user. The process 400 returns to decision point 420 and iterates as described above.

Returning to the description of decision point 420, in response to determining to determine the appropriate incentive for the user based upon entity interactions by the social network connections of the user, for example by determining that a monitored time period has expired or a configured count in the interaction counter threshold has been met, the process 400 transitions to the processing shown and described in association with FIG. 4B.

FIG. 4B illustrates additional processing associated with the process 400 for automated multi-channel, self-learning, social influence-based incentive generation. At block 430, the process 400 assigns a social networking influence to the user based upon the mapped number of monitored subsequent entity interactions determined to have been performed by the identified social network connections of the user. As such, a quantified influence rating may be assigned to the user based upon the number of entity interactions formed by friends and followers of the user in response to social networking actions related to marketplace offerings of entities within a social networking website environment.

At decision point 432, the process 400 makes a determination as to whether the assigned/determined social networking influence of the user is defined within one or more social networking influence incentive rules. One or more social networking influence incentive rules for the user may be identified within a social networking incentive profile of the user, as described above. Additional processing to retrieve social networking influence incentive rules, such as from the social networking influence incentive rules database 122, is omitted for brevity, but is understood to form a part of the process 400. Processing for a negative determination at decision point 432 will be deferred and described in more detail below.

In response to determining at decision point 432 that the assigned/determined social networking influence of the user is defined within one or more social networking influence incentive rules, the process 400 makes a determination at decision point 434 as to whether an incentive threshold within one or more social networking influence incentive rules has been satisfied by the assigned/determined influence of the user. Processing for a negative determination at decision point 434 will be deferred and described in more detail below.

In response to determining at decision point 434 that an incentive threshold within one or more social networking influence incentive rules has been satisfied by the assigned/determined influence of the user, the process 400 selects an incentive based upon the particular threshold that is satisfied from defined incentives using the incentive rule at block 436. At block 438, the process 400 generates the defined incentive for the user. Additional processing following the generation of the defined incentive for the user at block 438 will be deferred and described in more detail below.

Returning to the description of decision point 432, in response to determining that the assigned/determined social networking influence of the user is not defined within one or more social networking influence incentive rules, the process 400 makes a determination at decision point 440 as to whether the determined social networking influence of the user justifies a new social networking incentive and/or social networking influence incentive rule definition.

In response to determining at decision point 440 that the determined social networking influence of the user does not justify creation of a new social networking incentive and/or social networking influence incentive rule definition, or in response to determining at decision point 434 that an incentive threshold within one or more social networking influence incentive rules has not been satisfied by the assigned/determined influence of the user, the process 400 returns to the processing described in association with FIG. 4A at decision point 402 and iterates as described above.

Returning to the description of decision point 440, in response to determining that the determined social networking influence of the user justifies creation of a new social networking incentive and/or social networking influence incentive rule definition, the process 400 creates a new social networking influence incentive rule including a new social networking incentive definition at block 442. The new social networking influence incentive rule including the new social networking incentive may include multiple suggestions for incentives with differing influence thresholds as appropriate for a given implementation. As such, at block 444, the process 400 defines the determined social networking influence of the user as a new social networking incentive threshold within the new incentive definition of the new social networking influence incentive rule, and may add other thresholds for variance relative to the particular user's determined social networking influence, again as appropriate for the given implementation. At block 446, the process 400 defines an incentive (e.g., a gift certificate, a coupon, a “thank you” telephone call, etc.) as a new incentive within new social networking incentive definition of the new social networking influence incentive rule. At block 448, the process 400 generates the incentive for the user using the new social networking influence incentive rule.

In response to generating the defined incentive for the user at block 438 or in response to generating the incentive for the user using the new social networking influence incentive rule at block 448, the process 400 returns to the processing described in association with FIG. 4A at the location relative to the circled letter “B.”

Returning to the description of decision point 410 within FIG. 4A, it should be noted that where a negative reference is made and detected, for example to a competitor's product or service offering, an entity may find it to be desirable to promote their goods and services to the user as an alternative to the product or service offering of the competitor that motivated the negative reference. As such, in response to determining at decision point 410 that the detected marketplace offering reference associated with the social networking action of the user was a negative reference with respect to the marketplace offering, the process 400 identifies an offering similar to the negatively referenced offering of the competitor at block 450. At block 452, the process 400 generates an incentive for the user to consume/support the identified similar offering.

In response to generating the incentive at block 452 or in response to generation of the respective incentives described above at either block 438 or at block 448 of FIG. 4B, the process 400 sends the generated incentive to the user at block 454. The process 400 may also update the user incentive profile with the particular incentive that was generated and sent to the user for use during subsequent iterations of the process 400 to determine whether the incentive effectively incentivized the user, as described in more detail below. The process 400 transitions to the processing shown and described in association with FIG. 4C.

FIG. 4C illustrates additional processing associated with the process 400 for automated multi-channel, self-learning, social influence-based incentive generation. At decision point 456, the process 400 makes a determination as to whether the social networking influence of the user has changed over time. For example, users may become more popular and drive more influence over time irrespective of the particular incentives generated. As such, in response to determining that the social networking influence of the user has changed over time, the process 400 adjusts the social networking influence of the user within the incentive profile of the user based upon the changed social networking influence of the user over time at block 458. At decision point 460, the process 400 makes determination as to whether to change any incentives associated with social networking influence incentive rules or the user incentive profile based upon the changed influence of the user. In response to determining to change any incentives associated with social networking influence incentive rules or the user incentive profile based upon the changed influence of the user, the process 400 changes future suggestions of incentives for the user based upon the adjusted the social networking influence of the user within the incentive profile at block 462.

Returning to the description of decision point 456, in response to determining that the social networking influence of the user has not changed over time, or in response to determining not to change any incentives associated with social networking influence incentive rules or the user incentive profile based upon the changed influence of the user at decision point 460, or in response to changing future suggestions of incentives for the user at block 462, the process 400 makes a determination at decision point 464 as to whether any incentive(s), such as previous incentives documented in association with the user incentive profile as described above, that were generated using one or more social networking influence incentive rules during previous iterations of the process 400 effectively incentivized further positive social networking interactions by the user. In response to determining at decision point 464 that any incentive(s) generated using one or more social networking influence incentive rules during previous iterations of the process 400 did not effectively incentivize further positive social networking interactions by the user, the process 400 increases the respective incentive suggestions defined within the particular social networking influence incentive rule to attempt to further incentivize the user at block 466. The increased incentive may be defined within the particular social networking influence incentive rule and may be updated within the user's incentive profile for further processing during future iterations of the process 400.

In response to determining at decision point 464 that the incentive(s) generated using one or more social networking influence incentive rules during previous iterations of the process 400 did effectively incentivize further positive social networking interactions by the user, or in response to increasing the respective incentive defined within the particular social networking influence incentive rule to attempt to further incentivize the user at block 466, the process 400 returns to processing described in association with FIG. 4A at decision point 402 and iterates as described above.

As such, the process 400 detects social networking actions by a user within a social networking website that positively or negatively reference a marketplace offering of an entity. The process 400 monitors entity access channels and detects entity interactions by social networking relations (e.g., friends/followers, etc.) of the user that are responsive to the detected social networking action of the user. The process 400 determines a social networking influence of the user based upon the analyzed entity interactions. The process 400 further performs incentive profile processing for the user over time to generate incentives for users, and to evaluate both changes in the influence of the user over time and the effectiveness of generated incentives. The process 400 may further adjust the incentives based upon the determined incentive effectiveness.

As described above in association with FIG. 1 through FIG. 4C, the example systems and processes provide multi-channel, self-learning, social influence-based incentive generation. Many other variations and additional activities associated with multi-channel, self-learning, social influence-based incentive generation are possible and all are considered within the scope of the present subject matter.

Those skilled in the art will recognize, upon consideration of the above teachings, that certain of the above examples are based upon use of a programmed processor, such as the CPU 202. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
detecting, via a processor, a social networking action by a user within a social networking website that positively references a marketplace offering of an entity;
determining, in response to detecting the social networking interaction by the user, a social networking influence of the user based upon entity interactions by social network connections of the user with the entity via a plurality of entity access channels of the entity;
determining whether the determined social networking influence of the user satisfies a reward threshold defined within a social networking influence incentive rule; and
generating, in response to determining that the determined social networking influence of the user satisfies the incentive threshold defined within the social networking influence incentive rule, an incentive defined within the social networking influence incentive rule for the user.

2. The method of claim 1, where determining, in response to detecting the social networking interaction by the user, the social networking influence of the user based upon the entity interactions by the social network connections of the user with the entity via the plurality of entity access channels of the entity comprises:
identifying the social network connections of the user;
monitoring subsequent entity interactions with the entity via the plurality of entity access channels of the entity; and
calculating the social networking influence of the user based upon a number of the monitored subsequent entity interactions determined to have been performed by the identified social network connections of the user.

3. The method of claim 2, where calculating the social networking influence of the user based upon the number of the monitored subsequent entity interactions determined to have been performed by the identified social network connections of the user comprises:
analyzing the monitored subsequent entity interactions with the entity via the plurality of entity access channels of the entity;
determining the number of the monitored subsequent entity interactions with the entity via the plurality of entity access channels of the entity that were performed by the identified social network connections of the user;
mapping the number of the monitored subsequent entity interactions determined to have been performed by the identified social network connections of the user to the detected the social networking interaction by the user; and
assigning the social networking influence to the user based upon the mapped number of the monitored subsequent entity interactions determined to have been performed by the identified social network connections of the user.

4. The method of claim 1, further comprising:
determining that the determined social networking influence of the user is not defined within the social networking influence incentive rule;
determining whether the determined social networking influence of the user justifies a new social networking incentive definition;
creating, in response to determining that the determined social networking influence of the user justifies the new social networking incentive definition, a new social networking influence incentive rule comprising the new social networking incentive definition; and
generating the incentive for the user using the new social networking influence incentive rule.

5. The method of claim 4, where creating, in response to determining that the determined social networking influence of the user justifies the new social networking incentive definition, the new social networking influence incentive rule comprising the new social networking incentive definition comprises:
defining the determined social networking influence of the user as a new social networking incentive threshold within the new social networking incentive definition of the new social networking influence incentive rule; and
defining the incentive as a new incentive within the new social networking incentive definition of the new social networking influence incentive rule.

6. The method of claim 1, further comprising:
creating an incentive profile for the user based upon the determined social networking influence of the user;
monitoring the social networking influence of the user over time;
determining whether the social networking influence of the user has changed over time;
adjusting, in response to determining that the social networking influence of the user has changed over time, the social networking influence of the user within the incentive profile for the user based upon the changed social networking influence of the user over time; and
changing future suggestions of incentives for the user based upon the adjusted social networking influence of the user within the incentive profile for the user.

7. The method of claim 1, further comprising:
determining whether the generated incentive defined within the social networking influence incentive rule for the user effectively incentivized further positive social networking interactions by the user; and
increasing the incentive defined within the social networking influence incentive rule for the user in response to determining that the generated incentive defined within the social networking influence incentive rule for the user did not effectively incentivized further positive social networking interactions by the user.

8. A system, comprising:
a memory that stores social networking influence incentive rules; and
a processor programmed to:
detect a social networking action by a user within a social networking website that positively references a marketplace offering of an entity;
determine, in response to detecting the social networking interaction by the user, a social networking influence of the user based upon entity interactions by social network connections of the user with the entity via a plurality of entity access channels of the entity;
determine whether the determined social networking influence of the user satisfies a reward threshold defined within a social networking influence incentive rule; and
generate, in response to determining that the determined social networking influence of the user satisfies the incentive threshold defined within the social networking influence incentive rule, an incentive defined within the social networking influence incentive rule for the user.

9. The system of claim 8, where, in being programmed to determine, in response to detecting the social networking interaction by the user, the social networking influence of the user based upon the entity interactions by the social network connections of the user with the entity via the plurality of entity access channels of the entity, the processor is programmed to:
identify the social network connections of the user;
monitor subsequent entity interactions with the entity via the plurality of entity access channels of the entity; and
calculate the social networking influence of the user based upon a number of the monitored subsequent entity interactions determined to have been performed by the identified social network connections of the user.

10. The system of claim 9, where, in being programmed to calculate the social networking influence of the user based upon the number of the monitored subsequent entity interactions determined to have been performed by the identified social network connections of the user, the processor is programmed to:
analyze the monitored subsequent entity interactions with the entity via the plurality of entity access channels of the entity;
determine the number of the monitored subsequent entity interactions with the entity via the plurality of entity access channels of the entity that were performed by the identified social network connections of the user;
map the number of the monitored subsequent entity interactions determined to have been performed by the identified social network connections of the user to the detected the social networking interaction by the user; and
assign the social networking influence to the user based upon the mapped number of the monitored subsequent entity interactions determined to have been performed by the identified social network connections of the user.

11. The system of claim 8, where the processor is further programmed to:
determine that the determined social networking influence of the user is not defined within the social networking influence incentive rule;
determine whether the determined social networking influence of the user justifies a new social networking incentive definition;
create, in response to determining that the determined social networking influence of the user justifies the new social networking incentive definition, a new social networking influence incentive rule comprising the new social networking incentive definition, the processor being programmed to:
define the determined social networking influence of the user as a new social networking incentive threshold within the new social networking incentive definition of the new social networking influence incentive rule; and
define the incentive as a new incentive within the new social networking incentive definition of the new social networking influence incentive rule; and
generate the incentive for the user using the new social networking influence incentive rule.

12. The system of claim 8, where the processor is further programmed to:
create an incentive profile for the user based upon the determined social networking influence of the user;
monitor the social networking influence of the user over time;
determine whether the social networking influence of the user has changed over time;
adjust, in response to determining that the social networking influence of the user has changed over time, the social networking influence of the user within the incentive profile for the user based upon the changed social networking influence of the user over time; and
change future suggestions of incentives for the user based upon the adjusted social networking influence of the user within the incentive profile for the user.

13. The system of claim 8, where the processor is further programmed to:
determine whether the generated incentive defined within the social networking influence incentive rule for the user effectively incentivized further positive social networking interactions by the user; and
increase the incentive defined within the social networking influence incentive rule for the user in response to determining that the generated incentive defined within the social networking influence incentive rule for the user did not effectively incentivized further positive social networking interactions by the user.

14. A computer program product comprising a computer readable storage medium including computer readable program code, where the computer readable program code when executed on a computer causes the computer to:
detect a social networking action by a user within a social networking website that positively references a marketplace offering of an entity;
determine, in response to detecting the social networking interaction by the user, a social networking influence of the user based upon entity interactions by social network connections of the user with the entity via a plurality of entity access channels of the entity;
determine whether the determined social networking influence of the user satisfies a reward threshold defined within a social networking influence incentive rule; and
generate, in response to determining that the determined social networking influence of the user satisfies the incentive threshold defined within the social networking influence incentive rule, an incentive defined within the social networking influence incentive rule for the user.

15. The computer program product of claim 14, where in causing the computer to determine, in response to detecting the social networking interaction by the user, the social networking influence of the user based upon the entity interactions by the social network connections of the user with the entity via the plurality of entity access channels of the entity, the computer readable program code when executed on the computer causes the computer to:
identify the social network connections of the user;
monitor subsequent entity interactions with the entity via the plurality of entity access channels of the entity; and
calculate the social networking influence of the user based upon a number of the monitored subsequent entity interactions determined to have been performed by the identified social network connections of the user.

16. The computer program product of claim 15, where in causing the computer to calculate the social networking influence of the user based upon the number of the monitored subsequent entity interactions determined to have been performed by the identified social network connections of the user, the computer readable program code when executed on the computer causes the computer to:
analyze the monitored subsequent entity interactions with the entity via the plurality of entity access channels of the entity;
determine the number of the monitored subsequent entity interactions with the entity via the plurality of entity access channels of the entity that were performed by the identified social network connections of the user;
map the number of the monitored subsequent entity interactions determined to have been performed by the identified social network connections of the user to the detected the social networking interaction by the user; and
assign the social networking influence to the user based upon the mapped number of the monitored subsequent entity interactions determined to have been performed by the identified social network connections of the user.

17. The computer program product of claim 14, where the computer readable program code when executed on the computer further causes the computer to:
determine that the determined social networking influence of the user is not defined within the social networking influence incentive rule;
determine whether the determined social networking influence of the user justifies a new social networking incentive definition;
create, in response to determining that the determined social networking influence of the user justifies the new social networking incentive definition, a new social networking influence incentive rule comprising the new social networking incentive definition; and
generate the incentive for the user using the new social networking influence incentive rule.

18. The computer program product of claim 17, where in causing the computer to create, in response to determining that the determined social networking influence of the user justifies the new social networking incentive definition, the new social networking influence incentive rule comprising the new social networking incentive definition, the computer readable program code when executed on the computer causes the computer to:
define the determined social networking influence of the user as a new social networking incentive threshold within the new social networking incentive definition of the new social networking influence incentive rule; and
define the incentive as a new incentive within the new social networking incentive definition of the new social networking influence incentive rule.

19. The computer program product of claim 14, where the computer readable program code when executed on the computer further causes the computer to:
create an incentive profile for the user based upon the determined social networking influence of the user;
monitor the social networking influence of the user over time;
determine whether the social networking influence of the user has changed over time;
adjust, in response to determining that the social networking influence of the user has changed over time, the social networking influence of the user within the incentive profile for the user based upon the changed social networking influence of the user over time; and
change future suggestions of incentives for the user based upon the adjusted social networking influence of the user within the incentive profile for the user.

20. The computer program product of claim 14, where the computer readable program code when executed on the computer further causes the computer to:
determine whether the generated incentive defined within the social networking influence incentive rule for the user effectively incentivized further positive social networking interactions by the user; and
increase the incentive defined within the social networking influence incentive rule for the user in response to determining that the generated incentive defined within the social networking influence incentive rule for the user did not effectively incentivized further positive social networking interactions by the user.
